(19) United States
(12) Patent Application Publication
(10) Pub. No.: US 2025/0377979 A1
(43) Pub. Date: Dec. 11, 2025

(54) CONTROLLER AND STORAGE DEVICE

(71) Applicant: SK hynix Inc., Icheon-si (KR)

(72) Inventors: Hye Mi KANG, Icheon-si (KR); Min Jun JANG, Icheon-si (KR); Yong Ho KIM, Icheon-si (KR)

(21) Appl. No.: 19/260,199

(22) Filed: Jul. 3, 2025

Related U.S. Application Data
(63) Continuation-in-part of application No. 18/913,399, filed on Oct. 11, 2024.

(30) Foreign Application Priority Data
Jun. 10, 2024 (KR) 10-2024-0074685
Apr. 2, 2025 (KR) 10-2025-0042521

(51) Int. Cl. G06F 11/14; G06F 11/07; G06F 12/02

(52) U.S. Cl. CPC G06F 11/1451; G06F 11/0772; G06F 12/0253

(57) ABSTRACT

A storage device is provided to include: a memory including a plurality of storage blocks, each storage block including pages including a valid page to which valid data is written and a snapshot page that stores data corresponding to or associated with data in the valid page; and a controller in communication with the memory and configured to i) generate a valid segment including valid address data indicating an address of the valid page and valid map information indicating a storage location of the valid segment, ii) manage the valid page based on the valid segment and the valid map information, iii) generate a snapshot segment including snapshot address data indicating an address of the snapshot page and snapshot map information indicating a storage location of the snapshot segment, and iv) manage the snapshot page based on the snapshot segment and the snapshot map information.

### PRIORITY CLAIMS AND CROSS-REFERENCE TO RELATED APPLICATIONS

The present application is a Continuation-in-Part of pending U.S. patent application Ser. No. 18/913,399 filed on Oct. 11, 2024, which claims priority under 35 U.S.C. § 119(a) to Korean Patent Application No. 10-2024-0074685 filed in the Korean Intellectual Property Office on Jun. 10, 2024.

In addition, the present application claims priority under 35 U.S.C. § 119(a) to Korean Patent Application No. 10-2025-0042521 filed in the Korean Intellectual Property Office on Apr. 2, 2025.

The present application incorporates by reference of all of the above prior applications in their entirety as part of the disclosure of the present application.

### TECHNICAL FIELD

Various embodiments of the present disclosure generally relate to a controller and a storage device.

### BACKGROUND

A storage device may include at least one memory which stores data. The storage device may include a controller which controls the operation of the at least one memory.

For example, the controller may control an operation of writing data to the memory. The controller may control an operation of reading data written to the memory. The controller may control the operation of the memory on the basis of a command received from an external device or an internally generated command.

An abnormality may occur during the operation of the storage device, and power supplied to the storage device may be suddenly cut off. In this case, loss of data stored in the storage device may occur.

### SUMMARY

Embodiments of the present disclosure are directed to providing measures capable of efficiently recovering data stored in a storage device to a normal time point designated by a host device when an abnormality occurs during the operation of the storage device or the host device.

In an embodiment, a storage device may include: a memory including a plurality of storage blocks, each of the plurality of storage blocks including pages configured to store data, wherein the pages included in each of the plurality of storage blocks include a valid page to which valid data is written and a snapshot page that stores data corresponding to or associated with data in the valid page; and a controller in communication with the memory to access information in the memory on the valid page and the snapshot page and configured to i) generate a valid segment including valid address data indicating an address of the valid page and valid map information indicating a storage location of the valid segment, ii) manage the valid page based on the valid segment and the valid map information, iii) generate a snapshot segment including snapshot address data indicating an address of the snapshot page and snapshot map information indicating a storage location of the snapshot segment, and iv) manage the snapshot page based on the snapshot segment and the snapshot map information.

In an embodiment, a storage device may include: a memory configured to store data including a plurality of storage blocks, wherein at least one of the plurality of storage blocks stores N (N is an integer where N≥1) pages and the N pages include a valid page to which valid data is written and a snapshot page including information corresponding to the valid data; and a controller in communication with the memory and configured to i) generate a valid segment including valid address data indicating an address of the valid page and valid map information indicating a storage location of the valid segment, ii) manage the valid page using the valid segment and the valid map information, iii) generate a snapshot segment including snapshot address data indicating an address of the snapshot page and snapshot map information indicating a storage location of the snapshot segment, and iv) manage the snapshot page based on the snapshot segment and the snapshot map information, wherein at least one snapshot page is same as at least one valid page.

In an embodiment, a controller may include: a buffer memory; and a snapshot controller configured to i) load, into the buffer memory, a valid mapping table indicating a storage location of a valid page stored in an external memory and a valid count table indicating the number of valid pages, ii) generate, in response to performing a snapshot operation, a snapshot mapping table indicating a storage location of a snapshot page by copying the valid mapping table, and iii) generate a snapshot count table indicating the number of snapshot pages by copying the valid count table.

In an embodiment, a storage device may include: a memory including a plurality of storage blocks; and a controller configured to generate at least one snapshot block that stores snapshot pages the same as valid pages stored in at least one storage block of the plurality of storage blocks, determine a page sum using at least one of the number of the valid pages or the number of the snapshot pages depending on type information of each of the plurality of storage blocks set on the basis of a changed state, and control whether to maintain the at least one snapshot block by comparing the page sum with at least one preset threshold value.

In an embodiment, a storage device may include: memory including a plurality of storage blocks; and a controller configured to generate at least one snapshot block that stores snapshot pages the same as valid pages stored in at least one storage block of the plurality of storage blocks, and control whether to maintain the at least one snapshot block, using a page sum determined on the basis of a changed state of the valid pages stored in each of the plurality of storage blocks after the at least one snapshot block is generated.

In an embodiment, a storage device may include: a memory including a plurality of storage blocks; and a controller configured to generate at least one snapshot block that stores snapshot pages the same as valid pages stored in at least one storage block of the plurality of storage blocks, and control dropping of the at least one snapshot block on the basis of a command received from a host device after the at least one snapshot block is generated.

According to the embodiments of the present disclosure, it is possible to provide measures capable of facilitating recovery of data stored in a storage device when an abnormality occurs in the storage device, improving the operation efficiency of the storage device and minimizing decrease in data storage efficiency of the storage device.

### BRIEF DESCRIPTION OF THE DRAWINGS

FIG. 1 is a diagram illustrating an example of the schematic configuration of a storage device according to an embodiment of the present disclosure.

FIG. 2 is a diagram illustrating an example of a method in which a valid page is stored and managed in the storage device according to the embodiment of the present disclosure.

FIG. 3 is a diagram illustrating an example of a method in which a valid page and a snapshot page are managed in the storage device according to the embodiment of the present disclosure.

FIG. 4 is a diagram illustrating an example of a method in which an

operation according to a command is performed in a state in which a valid page and a snapshot page are stored in the storage device according to the embodiment of the present disclosure.

FIG. 5 is a diagram illustrating an example of a specific method in which a valid page is managed in the storage device according to the embodiment of the present disclosure.

FIG. 6 is a diagram illustrating an example of a specific method in which a valid page and a snapshot page are managed in the storage device according to the embodiment of the present disclosure.

FIGS. 7 to 9 are diagrams illustrating an example of a specific method in which an operation according to a command is performed in a state in which a valid page and a snapshot page are stored in the storage device according to the embodiment of the present disclosure.

FIG. 10 is a diagram illustrating an example of a specific method in which a garbage collection operation is performed in a state in which a valid page and a snapshot page are stored in the storage device according to the embodiment of the present disclosure.

FIG. 11 and FIG. 12 are diagrams illustrating an example of a method in which the storage device manages the type information of a storage block according to the embodiments of the present disclosure.

FIG. 13 is a diagram illustrating an example of a method in which the storage device determines a page sum depending on the type information of a storage block according to the embodiments of the present disclosure.

FIG. 14 to FIG. 16 are diagrams illustrating examples of a method in which the storage device controls dropping of snapshot data on the basis of a page sum according to the embodiments of the present disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another.

Various examples of embodiments of the present disclosure are described below with reference to accompanying drawings.

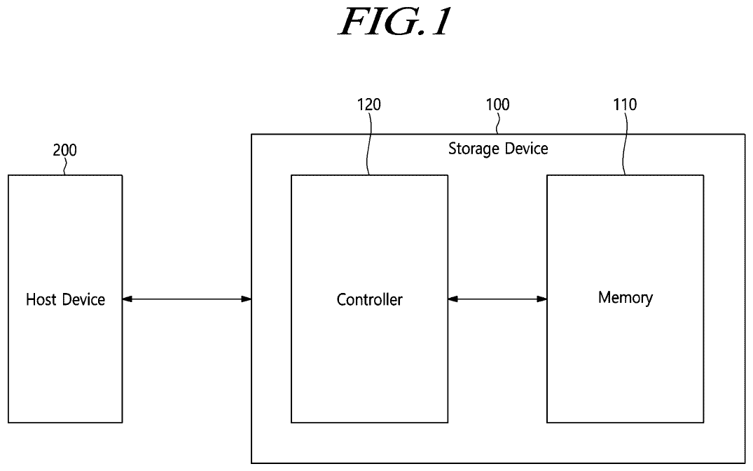

FIG. 1 is a diagram illustrating an example of the schematic configuration of a storage device 100 according to an embodiment of the present disclosure.

Referring to FIG. 1, the storage device 100 according to the embodiment of the present disclosure may include at least one memory 110. The storage device 100 may include a controller 120 which controls the operation of the memory 110.

The memory 110 may be, for example, volatile memory such as DRAM (dynamic random access memory), SDRAM (synchronous DRAM), DDR SDRAM (double data rate SDRAM) and LPDDR SDRAM (low-Power double data rate SDRAM), but the embodiment of the present disclosure is not limited thereto. The memory 110 may be nonvolatile memory such as NAND flash memory, 3D NAND flash memory and NOR flash memory. In some implementations, one part of the memory 110 included in the storage device 100 may be volatile memory, and the other part may be nonvolatile memory.

The memory 110 may include various types of memories such as resistive RAM, phase change memory, magnetoresistive memory, ferroelectric memory and spin transfer torque memory. In some implementations, the memory 110 may be processing-in-memory which includes a calculation function or a data processing function.

The memory 110 may include a plurality of storage blocks. Each of the plurality of storage blocks may include a plurality of memory cells configured to store data.

The controller 120 may receive a command from the outside, and may control the operation of the memory 110 on the basis of the received command. The controller 120 may control the operation of the memory 110 on the basis of an internally generated command. In the present specification, a command which the controller 120 receives from the outside may be referred to as an external command, and a command which is generated inside the controller 120 may be referred to as an internal command.

The controller 120 may control the operation of the memory 110 based on an external command or an internal command. For example, the controller 120 may control an operation of writing data to the memory 110. The controller 120 may control an operation of reading data written to the memory 110. Data may be transmitted and received between the controller 120 and the memory 110.

Depending on the type of the memory 110, the controller 120 may control a data preservation operation (e.g., a refresh operation or a patrol scrub operation) or an erase operation on data written to the memory 110.

The controller 120 may control the operation of the memory 110 on the basis of a command received from an external host device 200. The controller 120 may provide the host device 200 with a processing result according to an operation corresponding to the command. The controller 120 may transmit data or a response signal to the host device 200.

For example, the host device 200 may include or be a computer, an ultra mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a telematics network, an RFID (radio frequency identification) device, a mobility device (e.g., a vehicle, a robot or a drone) capable of traveling under human control or autonomous driving, or others. In some implementations, the host device 200 may include or be a virtual/augmented reality device which provides a 2D or 3D virtual reality image or augmented reality image. In some implementations, the host device 200 may include or be any one of various electronic devices each of which requires the storage device 100 capable of storing data.

The host device 200 may include at least one operating system. The operating system may manage and control overall functions and operations of the host device 200, and may control interoperations between the host device 200 and the storage device 100. The operating system may be classified into a general operating system and a mobile operating system depending on the mobility of the host device 200.

The controller 120 and the host device 200 may include or be devices which are separated from each other. In some implementations, the controller 120 and the host device 200 may be implemented by being integrated as one device, or some components or functions of the controller 120 may be implemented by being included in the host device 200. Hereunder, for the sake of convenience in explanation, it will be described as an example that the controller 120 and the host device 200 are devices which are separated from each other.

In order to maintain and improve the operation performance of the storage device 100, the controller 120 may perform a background operation associated with the memory 110 on the basis of an external command received from the host device 200 or on the basis of an internal command. A background operation may refer to an operation performed within the memory 110 without an intervention of the host device 200 by sending a command to the memory 110 from the host device 200 and without receiving and executing one or more commands from the host device 200. Some examples of the background operation may include, for example, at least one among garbage collection, wear leveling, read reclaim and bad block management operations. Based on control of the background operation, the controller 120 may improve the operation performance of the storage device 100 or prevent the operation performance from deteriorating.

The controller 120 may write data to the memory 110 and manage the data, based on a command received from the host device 200. The controller 120 may store and manage meta information for managing the data written to the memory 110. While the data written to the memory 110 includes valid data and invalid data, the controller 120 may separately manage the valid data from the invalid data.

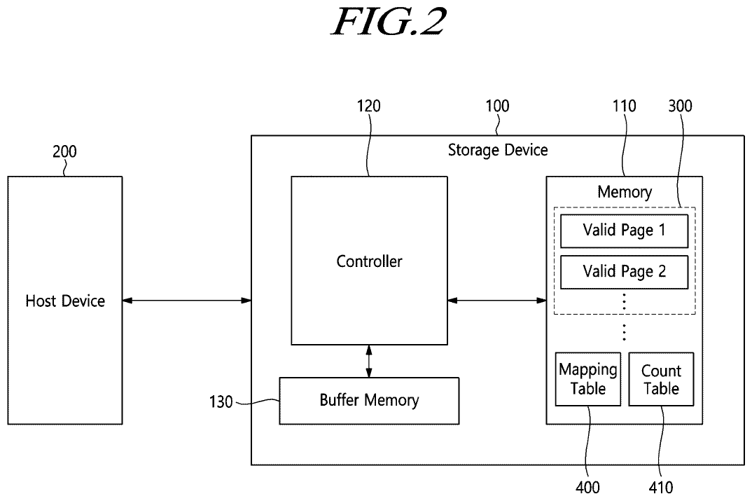

FIG. 2 is a diagram illustrating an example of a method in which a valid page is stored and managed in the storage device 100 according to the embodiment of the present disclosure.

Referring to FIG. 2, the memory 110 of the storage device 100 may include a plurality of storage blocks 300. Each of the plurality of storage blocks 300 may have a predetermined size. The controller 120 may store and manage data by the unit of storage block 300. In some implementations, the controller 120 may set and manage the size of the storage block 300 according to a request from the host device 200.

The storage block 300 may include a plurality of memory cells. Each of the plurality of memory cells may store, for example, 1 bit data. In some implementations, each of the plurality of memory cells may store 2 or 3 bit data, but is not limited thereto.

Two or more memory cells may constitute one page. The storage block 300 may include a plurality of pages.

The controller 120 may write data to a page of the storage block 300 according to a command from the host device 200. The page to which data is being written may be managed as a valid page. For example, when the data A is being written to the page A, the page A is managed as the valid page. After the data A is written to the page A, if the controller 120 receives a request to overwrite or update the data A to the data B from the host device 200, data B may be written to page A and data A previously written to the page A may be written to another page, page B. In this case, the controller 120 may manage the page A, to which data is overwritten or updated, as a valid page, and may manage the page B, to which the data A is written, as an invalid page.

The controller 120 may generate, store and manage various tables to write and manage data according to a command from the host device 200.

For example, the controller 120 may manage a valid mapping table 400 which includes information on a physical region to which data is written.

For example, the valid mapping table 400 may include information on the mapping relationship between the logical address of data according to a request from the host device 200 and the physical address of a region to which the data is written in the memory 110. The valid mapping table 400 may be provided in the form of a single table, or may be provided in a form in which at least two tables are combined.

The controller 120 may manage a valid count table 410 which includes information on the number of valid pages among pages included in each storage block 300.

For example, the valid count table 410 may provide information on the index of each storage block 300 and the number of valid pages included in each storage block 300. The number of valid pages provided by the valid count table 410 may be used in an operation for efficiently managing the storage block 300.

The controller 120 may store and manage the valid mapping table 400 and the valid count table 410 in a region other than a region where data is stored in the memory 110. In an operation, the controller 120 may load and use the valid mapping table 400 and the valid count table 410 written to the memory 110, in a buffer memory 130 included in the storage device 100.

The buffer memory 130 may include or be, for example, volatile memory such as SRAM or DRAM. The buffer memory 130 may be located outside the controller 120 or may be located inside the controller 120. The controller 120 may load the valid mapping table 400 and the valid count table 410 in the buffer memory 130, and may use the valid mapping table 400 and the valid count table 410 to write data to the storage block 300 of the memory 110 or read data written to the storage block 300. In some implementations, the controller 120 may store data, which is requested by the host device to write, to the buffer memory 130, and then, write the data by copying the data to the memory 110.

When an abnormal operation or a sudden power-off occurs in the storage device 100, the controller 120 may perform a snapshot operation for recovering data written to the storage block 300 of the memory 110. The snapshot operation may be an operation to preserve a data stored in the storage device 100 in a certain time. The preserved data may be used to recover the data stored in the storage device 100 in the certain time later. A snapshot data may be generated by the snapshot operation, and a type of the snapshot data may be various.

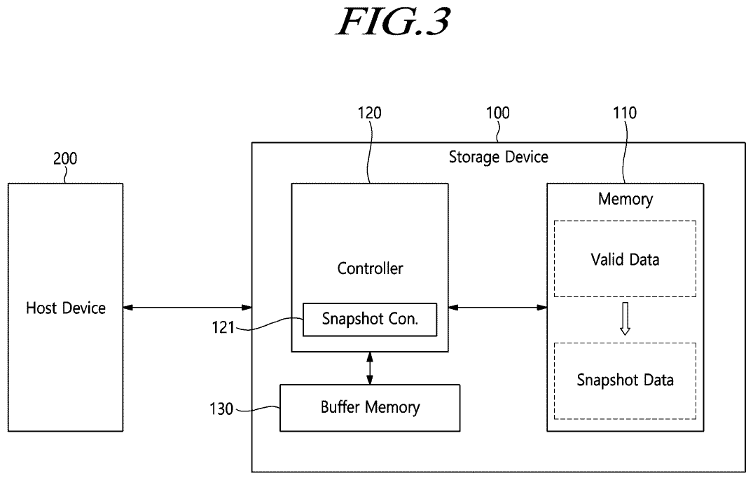

FIG. 3 is a diagram illustrating an example of a method in which a valid page and a snapshot page are managed in the storage device 100 according to the embodiment of the present disclosure.

Referring to FIG. 3, the controller 120 may include a snapshot controller 121.

The snapshot controller 121 may perform a snapshot operation at a preset time point.

In some implementations, the preset time point may mean, for example, a time point when a predetermined time elapses after the storage device 100 is turned on. In some implementations, the preset time point may mean a time point when the total operation time of the storage device 100 satisfies a certain condition, e.g., the total operation time of the storage device 100 becomes a predetermined time. In some implementations, the preset time point may mean a time point when the size of data stored in the memory 110 of the storage device 100 is equal to or larger than a predetermined size. In some implementations, the preset time point may refer to a time point when a snapshot request is received from the host device 200 or a time point that is designated according to a snapshot request received from the host device 200. The snapshot operation may be performed by a control initiated by the controller 120, and also, the snapshot operation may be performed by the snapshot request transmitted by the host device 200. The host device 200 may request for the storage device 100 to generate and manage the snapshot data which is used for preserving a data stored in the storage device 100 in a certain time and recovering the data later.

The preset time point is not limited to the examples described above. The snapshot controller 121 may perform a snapshot operation at each preset time point to manage data stored in the memory 110.

The snapshot controller 121 may generate snapshot data by performing the snapshot operation. In some implementations, the snapshot data may include data generated by copying valid data stored in the memory 110. A storage block 300 includes an area in which snapshot data is stored and another area in which valid data is stored. Thus, the area of the storage block 300 in which snapshot data is stored may be distinguished from another area of the storage block 300 in which valid data is stored. In this patent document, the area of the storage block 300 in which snapshot data is stored may be referred to as a snapshot block. In some implementations, the snapshot data may include data as discussed below.

For example, the snapshot data may be included in a snapshot page corresponding to a valid page included in a storage block 300. The snapshot page may be a copy of the valid page when the snapshot operation is performed. The snapshot data may include a table corresponding to the valid mapping table 400 which indicates the physical address of the valid page written to the storage block 300. The table corresponding to the valid mapping table 400 may be a copy of at least a part of the valid mapping table 400. The snapshot data may include a table corresponding to the valid count table 410 which includes information on the number of valid pages written to the storage block 300. The table corresponding to the valid count table 410 may be a copy of at least a part of the valid count table 410.

The snapshot data is not limited to the example described above, and may include valid data stored in the memory 110 and data required to manage the valid data. In some implementations, the snapshot data may include only a part of the above-described data. In some implementations, a snapshot page included in snapshot data may be regarded as a part of valid pages. Valid pages may include a page according to valid data stored in a storage block 300 and a page according to snapshot data stored in a snapshot block. When pages stored in the memory 110 are classified into valid pages and invalid pages, a snapshot page may also be classified into a valid page.

The snapshot controller 121 may generate the snapshot data by performing the snapshot operation at the preset time point, and may store and manage the snapshot data in the memory 110. In the state in which the snapshot data is stored by the snapshot controller 121, the controller 120 may control the operation of the memory 110 on the basis of an external command or an internal command.

When controlling the operation of the memory 110 by the controller 120, the snapshot data stored in the memory 110 may be managed. Management of the snapshot data after generation of the snapshot data may be performed by the snapshot controller 121, or may be performed by a component in the controller 120, which controls an operation according to an external command or an internal command.

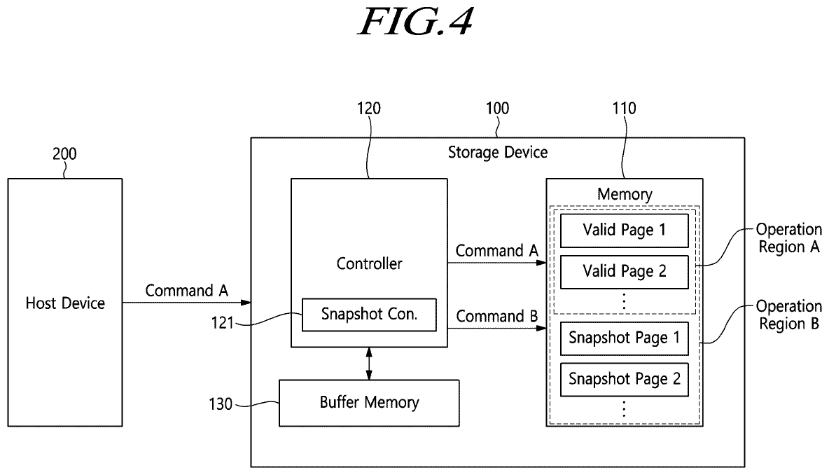

FIG. 4 is a diagram illustrating an example of a method in which an operation according to a command is performed in a state in which a valid page and a snapshot page are stored in the storage device 100 according to the embodiment of the present disclosure.

Referring to FIG. 4, a state in which a snapshot operation is performed by the snapshot controller 121 is illustrated as an example. A plurality of valid pages such as a first valid page and a second valid page may be stored in the memory 110.

As the snapshot operation is performed by the snapshot controller 121, a first snapshot page and a second snapshot page corresponding to the first valid page and the second valid page, respectively, may be generated. A snapshot page may store data corresponding to the data of a valid page, or may store data necessary to recover the data of a valid page. For example, the snapshot page (Snapshot Page 1) may store data corresponding to the data of the corresponding valid page (Valid Page 1) or data necessary to recover the data of the corresponding valid page (Valid Page 1). For example, the snapshot page (Snapshot Page 2) may store data corresponding to the data of the corresponding valid page (Valid Page 2) or data necessary to recover the data of the corresponding valid page (Valid Page 2).

In a state in which snapshot data is stored and managed in the memory 110, the controller 120 may control an operation according to a command received from the host device 200.

The controller 120 may control the operation of the memory 110 according to a command A received from the host device 200. According to the command A, the controller 120 may control an operation of writing data to the memory 110 or reading data written to the memory 110.

When controlling an operation according to the command A of the host device 200, the controller 120 may control an operation on a region where a valid page is written in the memory 110 (see Operation Region A in FIG. 4).

The controller 120 may not perform an operation on a region where the snapshot data is stored (see Operation Region B in FIG. 4). Since the snapshot data is data managed for recovery of data of a specific time point when an abnormality occurs in the operation of the storage device 100, the snapshot data may be maintained while not being changed when controlling the operation according to the command A received from the host device 200 after the snapshot operation. For example, the snapshot data may be a copy of a data stored in the storage device 100 in a certain time. While the data stored in the storage device 100 may be changed according to the time is passed, but the snapshot data may be maintained before a next snapshot operation is performed. Thus, the snapshot data may be used to recover the data stored in the storage device 100 in the certain time later. In some cases, the snapshot data may be deleted by a control of the controller 120. For example, the controller 120 may delete at least a part of the snapshot data for reserving a storage region.

The controller 120 may control the operation of the memory 110 based on an internally generated command B, which is different from the command A received from the host device 200.

The command B of the controller 120 may include or be, for example, a command which instructs a background operation such as a garbage collection or read reclaim operation. The controller 120 may perform a background operation to efficiently manage a storage region of the memory 110 and prevent an error from occurring depending on the number of times the storage region is used.

When performing a background operation by the controller 120, the background operation may be performed on a region where a valid page is written (see Operation Region A in FIG. 4) and a region where a snapshot page is written (see Operation Region B in FIG. 4). Since the background operation is an operation for efficient management of a storage region of the memory 110, the background operation may be performed also on a region where a snapshot page is stored (see Operation Region B in FIG. 4).

In some implementations, when performing an operation according to a command other than a write command or a read command received from the host device 200, the controller 120 may perform control on regions including a region where a snapshot page is stored. For example, according to a request from the host device 200, the controller 120 may control on an operation similar to garbage collection may be performed. In this case, the control may be performed on a region where a valid page is stored and a region where a snapshot page is stored.

When performing a background operation, the controller 120 may control an operation on a snapshot page corresponding to a valid page. This operation may include an operation of copying the snapshot page to another region.

When performing the background operation, the controller 120 may perform control even on tables which correspond to the valid mapping table 400 and the valid count table 410, respectively. Those tables are generated based on the snapshot operation and help the management of a valid page. For example, upon copying of the snapshot page, the controller 120 may update information of the tables for management of the snapshot page.

As a snapshot page corresponding to a valid page and tables corresponding to the valid mapping table 400 and the valid count table 410 for management of the valid page are managed by the controller 120, recovery based on snapshot data may be easily performed when an abnormality occurs in the storage device 100.

The valid mapping table 400 and the valid count table 410 for management of a valid page may be implemented in various forms. For example, the valid mapping table 400 may include at least two tables, and a snapshot operation according to the embodiment of the present disclosure may be applied to various forms of the valid mapping table 400 and the valid count table 410.

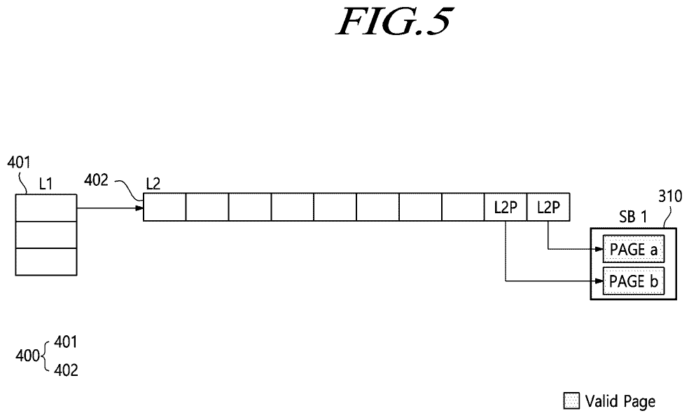

FIG. 5 is a diagram illustrating an example of a specific method in which a valid page is managed in the storage device 100 according to the embodiment of the present disclosure.

In an example as shown in FIG. 5, a page a and a page b are stored in a first storage block 310 among the plurality of storage blocks 300 included in the memory 110. In the example, the page a and the page b correspond to valid pages included in the first storage block 310 and data is written to the page a and the page b according to a write command from the host device 200.

The controller 120 may manage the valid mapping table 400 which indicates regions where the page a and the page b written to the first storage block 310 are stored. For example, the valid mapping table 400 may include valid map information 401 and a valid segment 402.

The valid map information 401 may indicate the location of the valid segment 402. The valid map information 401 may also be referred to as an L1 mapping table. For example, the valid map information 401 may have a size smaller than the size of the valid segment 402.

The valid segment 402 may include valid address data. The valid address

data may indicate the physical address of a region where a valid page is written in the memory 110. The valid address data may include mapping information between a logical address indicated by the host device 200 and a physical address of a valid page in the memory.

For example, as in the example illustrated in FIG. 5, the valid address data

included in the valid segment 402 may indicate the physical address of a region where the page a is stored and the physical address of a region where the page b is stored.

In response to a write command from the host device 200, the controller 120 may set the information of the valid mapping table 400 and may write data to the regions of the first storage block 310 corresponding to the valid address data. When receiving a read command from the host device 200, the controller 120 may read data written to a physical address corresponding to a logical address according to the read command using the information included in the valid mapping table 400, and may provide the read data to the host device 200.

The description of the valid mapping table 400 for indicating and managing the region of data written to a storage block 300 is provided an example, and other implementations are possible. For example, data stored in a storage block 300 may be managed by various implementations of the valid mapping table 400.

In some implementations, a page where data is stored in a storage block 300 may be a valid page or may be a snapshot page which is generated according to a snapshot operation. In some implementations, a page where data is stored in a storage block 300 may operate as a valid page and a snapshot page at the same time.

When a snapshot operation is performed, the controller 120 may generate and manage snapshot data based on a valid page. The snapshot data may include a snapshot mapping table corresponding to the valid mapping table 400 for management of a valid page.

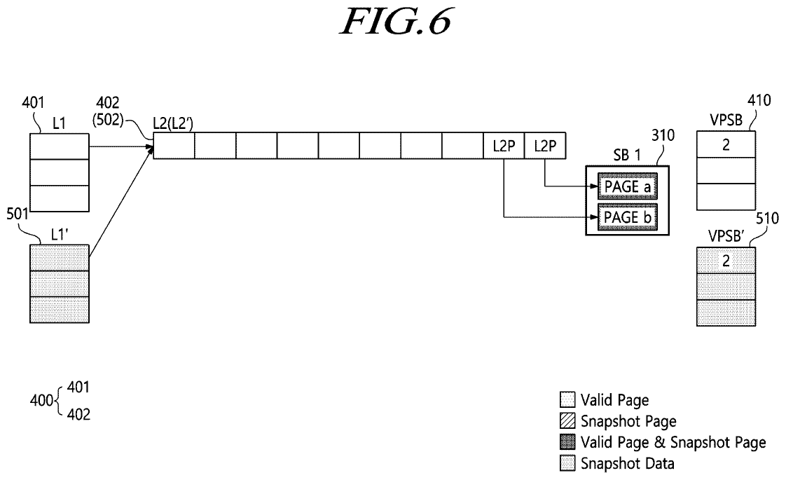

FIG. 6 is a diagram illustrating an example of a method in which a valid page and a snapshot page are managed in the storage device 100 according to the embodiment of the present disclosure.

In the example as shown in FIG. 6, a snapshot operation is performed by the snapshot controller 121 of the controller 120. The controller 120 may generate snapshot data according to the snapshot operation.

For example, the controller 120 may generate a snapshot page corresponding to a valid page. In the example, in order for the efficient use of the storage space of the memory 110, the controller 120 may manage snapshot data without copying the valid page during the snapshot operation.

For example, according to the snapshot operation, the controller 120 may generate snapshot map information 501 corresponding to the valid map information 401. The snapshot map information 501 may include the same information as the valid map information 401. The snapshot map information 501 may be referred to as an L1′ mapping table.

According to the snapshot operation, the controller 120 may generate a snapshot count table 510 corresponding to the valid count table 410.

For example, when two valid pages including “PAGE a” and “PAGE b” are stored in the first storage block 310, the number of valid pages for the first storage block 310 becomes 2. In the same manner as the valid count table 410, the snapshot count table 510 may be generated to include information indicating that the number of snapshot pages for the first storage block 310 is 2.

The controller 120 may complete the snapshot operation by generating the snapshot map information 501 corresponding to the valid map information 401 and the snapshot count table 510 corresponding to the valid count table 410. The amount of data generated according to the snapshot operation may not be large.

The snapshot map information 501 generated by the controller 120 may indicate the location of a snapshot segment 502. The snapshot segment 502 may include snapshot address data as mapping information on the physical address of a region where a snapshot page is stored.

As the controller 120 performs the snapshot operation, the “PAGE a” and the “PAGE b,” to which data is written in the first storage block 310, may be managed as not also the valid pages but also the snapshot pages. In this implementation, the “PAGE a” and the “Page b” may be considered as the valid pages and the snapshot pages at the same time.

Immediately after or after the snapshot operation is performed, when assuming that the number of pages to which data is written in the storage block 300 is N, the sum of the number of valid pages managed by the valid count table 410 and the number of snapshot pages managed by the snapshot count table 510 becomes 2N.

Since the numbers of pages to which data is written are managed by the valid count table 410 and the snapshot count table 510, respectively, the sum of the number of valid pages managed by the valid count table 410 and the number of snapshot pages managed by the snapshot count table 510 may be equal to or greater than the number of pages to which data is written in the storage block 300.

Immediately after or after the snapshot operation is performed, the snapshot segment 502 may be the same as the valid segment 402. The valid segment 402 may be indicated by the snapshot map information 501. The snapshot map information 501 may indicate the valid segment 402, and the valid segment 402 may be in a state in which it is indicated by the valid map information 401 and the snapshot map information 501.

Even when the valid mapping table 400 includes the valid map information 401 and the valid segment 402, since only the snapshot map information 501 corresponding to the valid map information 401 and the snapshot count table 510 corresponding to the valid count table 410 are generated in the snapshot operation, the amount of data generated according to the snapshot operation may be reduced.

After performing the snapshot operation, the controller 120 may manage snapshot data along with valid data when controlling the operation of the memory 110 according to at least one of an external command from the host device 200 or an internal command by the controller 120.

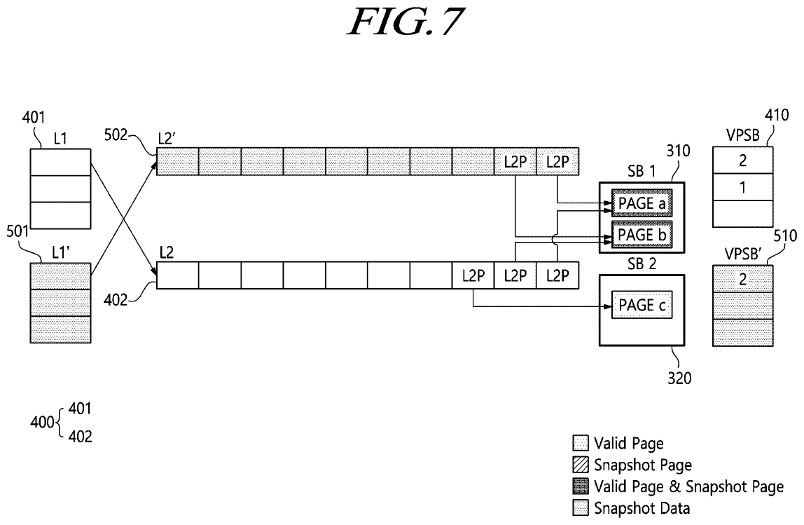

FIGS. 7 to 9 are diagrams illustrating an example of a specific method in which an operation according to a command is performed in a state in which a valid page and a snapshot page are stored in the storage device 100 according to the embodiment of the present disclosure.

Referring to FIG. 7, a case where, after the snapshot operation according to the example illustrated in FIG. 6 is performed, data is written to a storage block 300 of the memory 110 according to a write command received from the host device 200 is illustrated as an example.

For example, after performing the snapshot operation, the controller 120 may receive, from the host device 200, a write command which instructs to write new data.

According to the snapshot operation, the controller 120 may manage the snapshot map information 501 corresponding to the valid map information 401 and the snapshot count table 510 corresponding to the valid count table 410. Since the valid map information 401 and the snapshot map information 501 indicate the same valid segment 402, the valid segment 402 and the snapshot segment 502 may exist as one data.

According to the write command from the host device 200, the controller 120 may perform an operation for writing data to a new region of a storage block 300.

For example, the controller 120 may write a page c to a second storage block 320. The page c may be a valid page.

The controller 120 may store, in the valid segment 402, mapping information between the physical address of a region where the page c is written in the second storage block 320 and a logical address according to the write command from the host device 200. The valid segment 402 may be updated.

The controller 120 may change the valid map information 401 to indicate the updated valid segment 402.

As the valid segment 402 is updated, the controller 120 may separately manage the snapshot segment 502. Upon an occurrence of the update of the valid segment 402, the valid segment 402, which is before the update, is managed as the snapshot segment 502 and the updated valid segment 402 is newly generated as the new valid page.

As the new valid page is added to the second storage block 320, the valid count table 410 may be updated. By the valid count table 410, it may be managed that the number of valid pages stored in the first storage block 310 is 2 and the number of valid pages stored in the second storage block 320 is 1.

The valid count table 410 may be updated, and the snapshot count table 510 may be maintained. The snapshot count table 510 may include information indicating a state in which data is written to the memory 110 in the snapshot operation. Since the snapshot count table 510 is maintained without changes, the snapshot count table 510 may maintain information indicating that the number of snapshot pages stored in the first storage block 310 is 2.

When the valid page is added according to the write command from the host device 200, the snapshot map information 501 and the snapshot count table 510 of the snapshot data may maintain the states as they are regardless of the added valid page. According to the update of the valid segment 402, data may increase by only the amount of data corresponding to the updated valid segment 402 without any changes to the snapshot data.

An operation of writing new data and an operation of managing snapshot data according to a snapshot operation may be performed while minimizing the use of the storage space of the memory 110.

According to a command from the host device 200, the controller 120 may perform an operation of deleting or updating data stored in the memory 110.

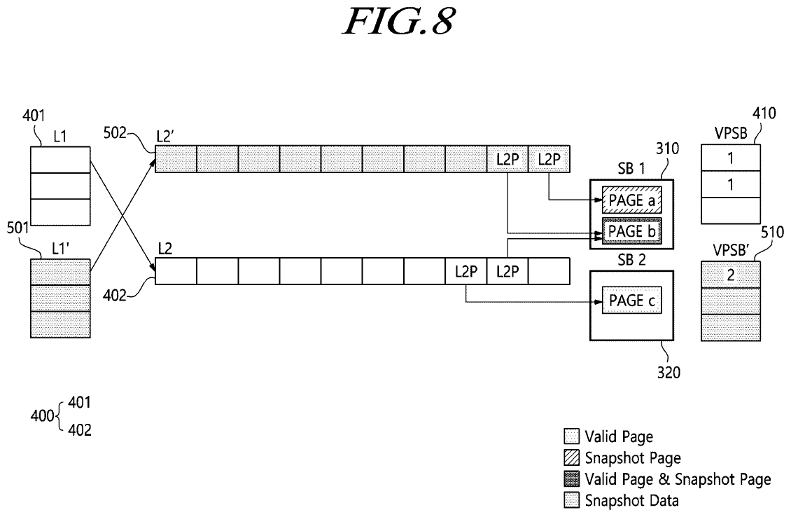

For example, referring to FIG. 8, the controller 120 may receive, from the host device 200, a command to delete the “PAGE a” stored in the first storage block 310 or delete the mapping relationship for the “PAGE a.” In some other implementations, the controller 120 may receive, from the host device 200, a command to update the “PAGE a” stored in the first storage block 310.

According to the command to delete the “PAGE a” stored in the first storage block 310 or delete the mapping relationship for the “PAGE a,” which is received from the host device 200, the controller 120 may delete data indicating the physical address of the region where the “PAGE a” is stored among the valid address data included in the valid segment 402. In some other implementations, the controller 120 may delete the mapping relationship between the valid address data of the valid segment 402 and the “PAGE a” of the first storage block 310.

Since the “PAGE a” stored in the first storage block 310 is not a page which is indicated by the valid segment 402, the “PAGE a” may not be a valid page any longer. The controller 120 may update the valid count table 410. The updated valid count table 410 may indicate information representing a state in which one valid page is stored in the first storage block 310 and one valid page is written to the second storage block 320.

In some implementations, the “PAGE a” may not be a valid page but may be a snapshot page. The “PAGE a” may be a page which is managed for a recovery operation based on the snapshot operation. In this patent document, if there is a page in the memory, to which data is written, while the page being neither a valid page nora snapshot page, such page may be referred to as an invalid page.

The controller 120 may manage data stored in the memory 110 while updating the valid segment 402 and the valid count table 410 according to the command from the host device 200.

Since the snapshot data according to the snapshot map information 501, the snapshot segment 502 and the snapshot count table 510 is maintained, the information on the “PAGE a” and the “PAGE b” corresponding to the snapshot pages when performing the snapshot operation may be managed.

Similarly, even in a case where an existing valid page is updated, the snapshot data may be managed while an operation of updating the valid page is performed.

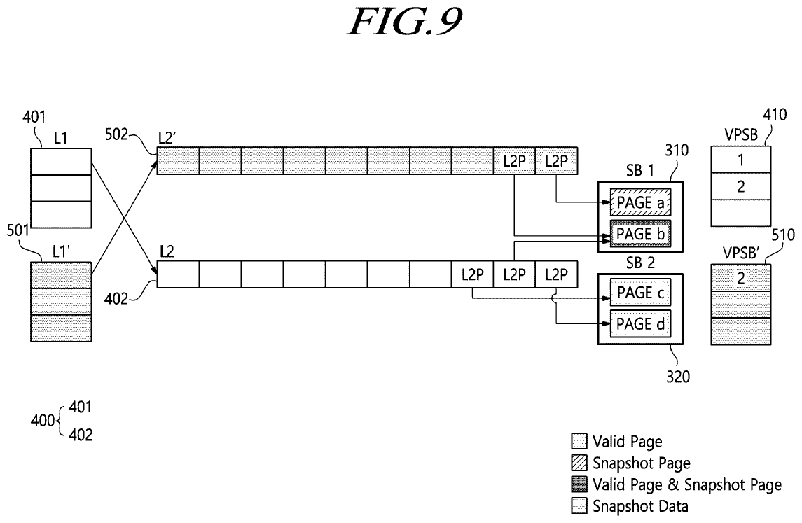

For example, referring to FIG. 9, the controller 120 may receive, from the host device 200, a command which instructs to update the “PAGE a” stored in the first storage block 310.

According to the command from the host device 200, the controller 120 may proceed to make the “PAGE a” stored in the first storage block 310 be not a valid page any longer, and may write a page d to another region. For example, the controller 120 may write the page d to the second storage block 320.

Information indicating the physical address of a region where the page d of the second storage block 320 as a valid page is stored may be added to the valid segment 402. The number of valid pages in the first storage block 310 may decrease by 1, and the number of valid pages in the second storage block 320 may increase by 1. The controller 120 may update information in the valid count table 410.

After the existing “PAGE a” is updated according to the command from the host device 200, the “PAGE a” stored in the first storage block 310 may be managed as a snapshot page. The “PAGE b” stored in the first storage block 310 may be managed as a valid page and a snapshot page at the same time.

The “PAGE c” and the “PAGE d” stored in the second storage block 320 may be managed as valid pages.

Since the controller 120 manages a valid page using the valid mapping table 400 and the valid count table 410 and manages snapshot data using the snapshot mapping table and the snapshot count table 510 corresponding to the valid mapping table 400 and the valid count table 410, respectively, snapshot data may be managed while minimizing an increase in the number of snapshot pages.

By managing a valid page and a snapshot page according to a command from the host device 200 after performing a snapshot operation, the controller 120 may easily perform a recovery operation based on the snapshot operation when an abnormality occurs in the storage device 100.

In a state in which snapshot data is generated, the controller 120 may perform a background operation to improve the operation efficiency of the storage device 100. In this case, a snapshot page included in the snapshot data may also be a target for the background operation.

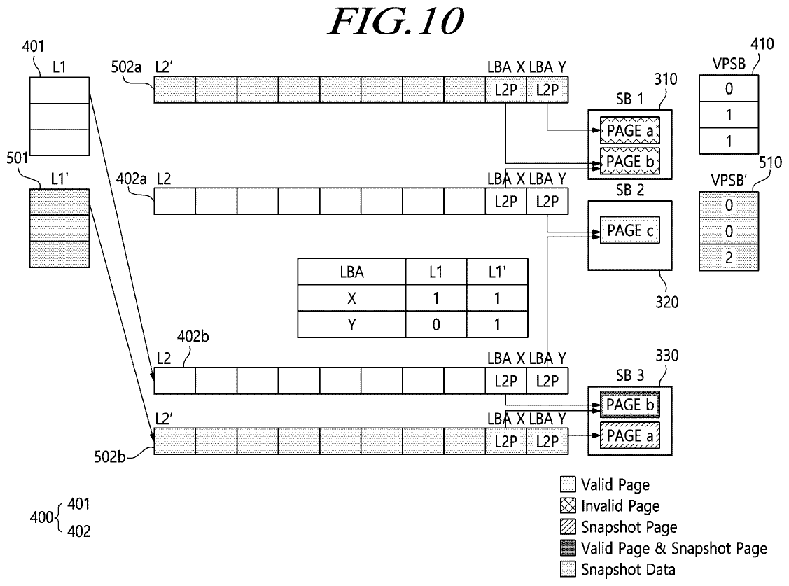

FIG. 10 is a diagram illustrating an example of a specific method in which a garbage collection operation is performed in a state in which a valid page and a snapshot page are stored in the storage device 100 according to the embodiment of the present disclosure.

In the example as shown in FIG. 10, a garbage collection operation is performed in a state in which a first valid segment 402a is indicated by valid map information 401 and a first snapshot segment 502a is indicated by snapshot map information 501 is illustrated as an example.

Before the garbage collection operation is performed, the example shows a state in which a “PAGE a” and a “PAGE b” are written to a first storage block 310, and a “PAGE c” is written to a second storage block 320.

In the example as shown in FIG. 10, the “PAGE a” and the “PAGE b” are indicated by logical addresses Y and X, respectively, included in the first snapshot segment 502a. The “PAGE a” and the “PAGE b” may correspond to snapshot pages.

In addition, the “PAGE b” is indicated by a logical address X included in the first valid segment 402a. Thus, the “PAGE b” may correspond to both a snapshot page and a valid page.

In the example as shown in FIG. 10, the “PAGE c” is indicated by a logical address Y included in the first valid segment 402a. The page c may correspond to a valid page.

When the “PAGE a,” the “PAGE b” and the “PAGE c” are written to the first storage block 310 and the second storage block 320 as described above, the controller 120 may select a victim storage block and a target storage block for the garbage collection operation.

For example, when the number of free storage blocks 300 is insufficient or it is expected that the number of free storage blocks 300 is to be insufficient, the controller 120 may copy a valid page from a victim storage block to a target storage block.

When selecting a victim storage block, the controller 120 may select the victim storage block on the basis of the number of pages which needs to be moved from the victim storage block. The controller 120 may select a victim storage block on the basis of a larger value of the numbers of valid pages and snapshot pages stored in each storage block 300.

For example, the controller 120 may select, as a victim storage block, a storage block 300 with a smallest value among larger values of the numbers of valid pages and snapshot pages stored in storage blocks 300. Since a victim storage block is selected by considering even the numbers of snapshot pages, it is possible to prevent the efficiency of the garbage collection operation from deteriorating due to movement of snapshot pages.

For example, the garbage collection operation is performed in a case where the first storage block 310 is selected as a victim storage block and a third storage block 330 is selected as a target storage block.

The “PAGE a” stored in the first storage block 310 may be copied to the third storage block 330. Since the “PAGE a” corresponds to only a snapshot page, the snapshot address data of the logical address Y indicating the “PAGE a” in the first snapshot segment 502a may be updated to indicate the physical address of a region where the “PAGE a” is stored in the third storage block 330. As the first snapshot segment 502a is updated, a second snapshot segment 502b may be generated.

The “PAGE b” stored in the first storage block 310 may be copied to the third storage block 330. Since the “PAGE b” operates as a valid page and a snapshot page at the same time, the first valid segment 402a and the first snapshot segment 502a may be updated.

The logical address X indicating the page b of the first storage block 310 in the first valid segment 402a may be updated to indicate the page b copied to the third storage block 330. As the first valid segment 402a is updated, a second valid segment 402b may be generated.

The logical address X indicating the page b of the first storage block 310 in the first snapshot segment 502a may be updated to indicate the page b copied to the third storage block 330.

The page c of the second storage block 320 may remain as a valid page without being moved. The second valid segment 402b may indicate the physical address of the page c stored in the second storage block 320.

By the garbage collection operation, the “PAGE a” and the “PAGE b” stored in the first storage block 310 may be neither valid pages nor snapshot pages. The “PAGE a” and the “PAGE b” stored in the first storage block 310 may be invalid pages.

The “PAGE c” stored in the second storage block 320 may be a valid page.

The “PAGE b” stored in the third storage block 330 may be a valid page and at the same time a snapshot page. The “PAGE a” stored in the third storage block 330 may be not a valid page but a snapshot page.

According to the garbage collection operation, the valid count table 410 may represent information indicating that one valid page exists in each of the second storage block 320 and the third storage block 330. The snapshot count table 510 may represent information indicating that two snapshot pages exist in only the third storage block 330.

Even after snapshot data is generated, a garbage collection operation for efficient use of the storage blocks 300 of the memory 110 may be performed. In addition, in order to reduce the amount of data or the number of times data is copied during the garbage collection operation, data copying may be performed on the basis of whether data to be copied is a valid page or a snapshot page or corresponds to both a valid page and a snapshot page.

For example, since the page b to be copied among the pages stored in the first storage block 310 is indicated by the logical address X of the first valid segment 402a and the logical address X of the first snapshot segment 502a, the first valid segment 402a and the first snapshot segment 502a may be updated as the page b is copied to the third storage block 330 only once. On the basis of whether a page stored in a storage block 300 corresponds to a valid page and/or a snapshot page before copying data according to garbage collection, a garbage collection operation may be performed while reducing the number of times data is copied.

In addition, depending on the type of a storage block 300, the controller 120 may use only a part of valid data or snapshot data in a garbage collection operation. For example, in order to improve the performance of a garbage collection operation, the controller 120 may check whether all of pages stored in a storage block 300 are data newly stored after a snapshot operation. If all of pages stored in a storage block 300 are data newly stored after a snapshot operation, snapshot data for the corresponding pages may not exist. The controller 120 may perform a garbage collection operation without checking the snapshot count table 510 and by checking only the valid count table 410. The controller 120 may efficiently perform a garbage collection operation depending on the type of a storage block 300 while managing snapshot data.

The above-described example illustrates a garbage collection operation, but the embodiment of the present disclosure may also be applied to other background operations. For example, when a read reclaim operation is performed, a valid page and a snapshot page included in a storage block selected as a data copying target may be copied to another storage block. Even in this case, data copying may be performed on the basis of whether a corresponding page corresponds to only a valid page, only a snapshot page or both a valid page and a snapshot page.

In some implementations, the controller 120 may determine whether to maintain the generated snapshot data. Such determination may be made periodically or when a predetermined condition is satisfied or a specific command is generated. The controller 120 may control whether to drop snapshot data. Dropping of snapshot data may mean deleting snapshot data or managing snapshot data by changing the snapshot data into an invalid page.

The controller 120 may control dropping of snapshot data under the control of the host device 200.

In some implementations, the controller 120 may control dropping of snapshot data on the basis of the size of data stored in the memory 110. The dropping of the data may be performed for the improved storage management and refer to intentionally lose or get rid of data, make the data as invalid, or others. The controller 120 may determine whether to drop snapshot data based on the number of valid pages or the number of snapshot pages stored in the memory 110. When using the number of valid pages or the number of snapshot pages to determine whether to drop snapshot data, the controller 120 may determine the number of pages to be used, depending on the type of each storage block 300 in which pages are stored.

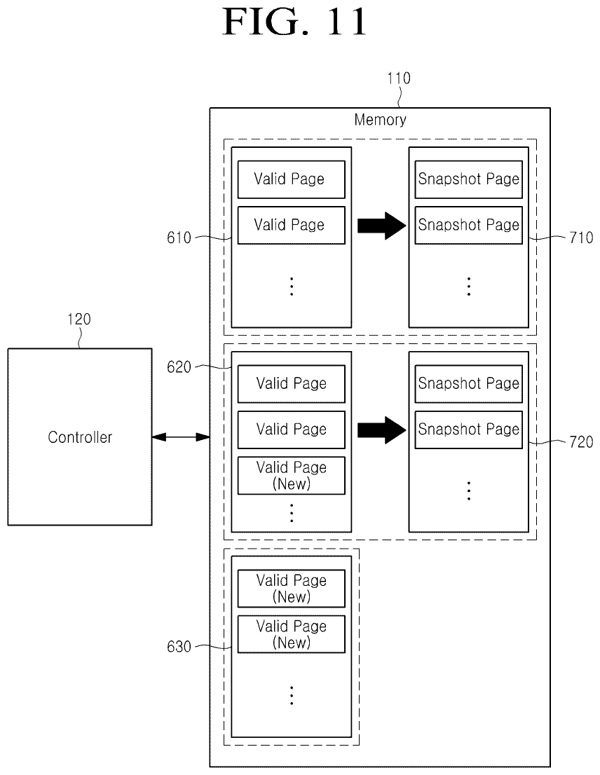

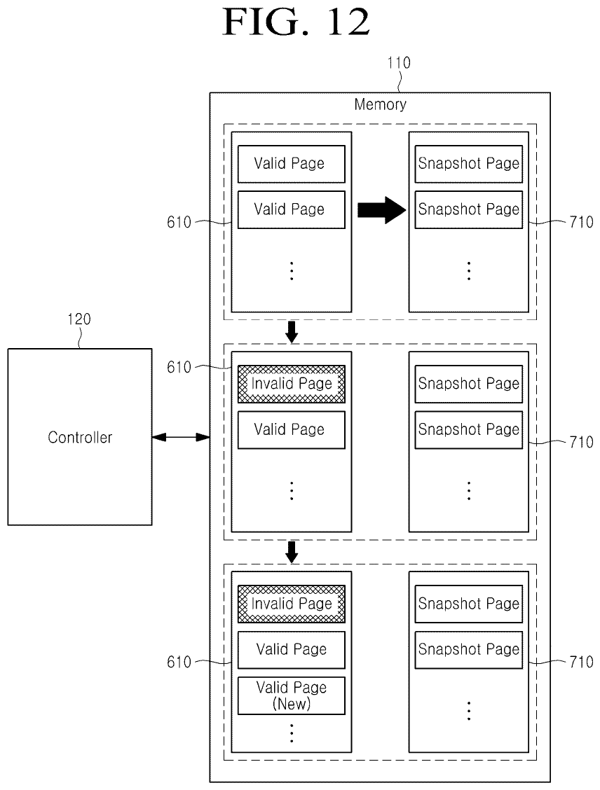

FIG. 11 and FIG. 12 are diagrams illustrating an example of a method in which the storage device manages the type information of a storage block based on some implementations of the disclosed technology.

Referring to FIG. 11, a case where snapshot data for valid pages stored in the memory 110 is generated is illustrated as an example. For the sake of convenience in explanation, a storage block 300 in which valid pages are stored may be referred to as a normal block, and a storage block 300 in which snapshot data is stored may be referred to as a snapshot block.

Valid pages may be stored in a first normal block 610. The controller 120 may generate snapshot data for the valid pages stored in the first normal block 610. A first snapshot block 710 in which the snapshot data is stored may be generated.

The controller 120 may generate the first snapshot block 710 for the first normal block 610, and may manage the type information of the first normal block 610. Because the valid pages stored in the first normal block 610 and snapshot pages stored in the first snapshot block 710 are the same, the controller 120 may manage the type information of the first normal block 610 as a first type which means a state in which pages stored in a normal block and a snapshot block are the same. Thus, in the present specification, the first type may indicate that the normal block and the snapshot block have same pages and may be referred to as a “Same” state.

The type information of a storage block 300 may be managed in various manners. For example, the type information of the storage block 300 may be stored in the corresponding storage block 300 or stored in a region that stores the management information of each storage block 300 in the memory 110.

In another example, the controller 120 may generate snapshot data in a state in which valid pages are stored in a second storage block 620. A second snapshot block 720 that stores snapshot pages the same as the valid pages stored in the second storage block 620 may be generated.

After the second snapshot block 720 is generated, the controller 120 may add a valid page to the second storage block 620. The corresponding valid page may be a page that is written according to a command received before or after the second snapshot block 720 is generated.

When a new valid page is added to a normal block after a snapshot operation, the controller 120 may manage the type information of the corresponding normal block as a second type. The controller 120 may manage the type information of the second storage block 620 as the second type which may be referred to as a “New” state. Thus, in the present specification, the second type may indicate that the corresponding normal block has a new valid page added to the corresponding normal block after a snapshot operation and be referred to as a “New” state.

In some implementations, after a snapshot operation by the controller 120, a new storage block may be opened, and new valid pages may be written to the new storage block.

For example, FIG. 11 shows a third normal block 630. Referring to FIG. 11, there may be a storage block 300 that is newly generated after a snapshot operation is performed by the controller 120. There may not be a snapshot block that corresponds to the third normal block 630. All valid pages stored in the third normal block 630 may be data that is written after a previous snapshot operation. The controller 120 may manage the type information of the third normal block 630 as the second type. Thus, the third normal block 630 has the type information, the second type, which is same as the type information of the second storage block 620 having the new valid page added after a snapshot operation for the second storage block 620 is performed. In this case, the controller 120 may manage the third normal block 630 as same as the second normal block 620 that includes a new valid page added after a snapshot operation.

In some implementations, after a snapshot operation is performed, a valid page stored in a normal block may be changed to an invalid page.

For example, referring to FIG. 12, in a state in which valid pages are stored in a first normal block 610, the controller 120 may generate a first snapshot block 710 that includes snapshot pages that are same as the valid pages stored in the first normal block 610.

Because it is a state in which the valid pages stored in the first normal block 610 and the snapshot pages stored in the first snapshot block 710 are the same, the controller 120 may manage the type information of the first normal block 610 as the first type.

After the first snapshot block 710 is generated, at least a part of the valid pages stored in the first normal block 610 may be changed to an invalid page.

For example, at least a part of the valid pages stored in the first normal block 610 at the time of generating the first snapshot block 710 may be changed to an invalid page after the generation of the first snapshot block 710. A valid page of the first normal block 610 may be changed to an invalid page according to a command from the host device 200. In some implementations, a valid page of the first normal block 610 may be changed to an invalid page by a garbage collection operation by the controller 120, etc.

The first snapshot block 710 may be in a state of storing the snapshot pages that are same as the valid pages stored in the first normal block 610 when a snapshot operation is performed by the controller 120. The controller 120 may manage the type information of the first normal block 610 as a third type. The third type may mean a case where a normal block includes an invalid page that occurs after a snapshot operation. In the present specification, the third type may be referred to as an “Old” state.

A new valid page may be added in a state in which an invalid page occurs in a normal block.

For example, in a state in which a valid page and an invalid page are stored in the first normal block 610, a new valid page may be added. While FIG. 12 shows the example where a valid page stored in the first normal block 610 is changed to an invalid page after the snapshot operation and a new valid page is added to the first normal block 610, the description for such example can be applied to even a case where a new valid page is added to the first normal block 610 after the snapshot operation and then a valid page stored in the first normal block 610 is changed to an invalid page. The snapshot pages of the first snapshot block 710 may be maintained in a state in which they are generated during the snapshot operation. The first normal block 610 corresponding to the first snapshot block 710 may store a valid page that exists when performing the snapshot operation, an invalid page that occurs after the snapshot operation, and a valid page that is added after the snapshot operation. In the first normal block 610, an invalid page may occur first, or a new valid page may be added first.

The controller 120 may manage the type information of a normal block including at least one invalid page that occurs after a snapshot operation and at least one new valid page that is added after the snapshot operation, as a fourth type. In the present specification, the fourth type may be referred to as a “Mixed” state.

The controller 120 may manage the type information of each storage block 300 depending on a change state of valid pages stored in a normal block after a snapshot operation. The change state may indicate whether a change has occurred to the valid pages stored in the normal block after the snapshot operation and information on how the valid pages are changed in case that the change has occurred. The controller 120 may determine a page sum for managing snapshot data, on the basis of the type information of each storage block 300. It may also be regarded that the controller 120 determines a page sum on the basis of a change state of pages stored in a normal block after a snapshot operation.

When a page sum is determined, the controller 120 may determine whether to maintain (or drop) snapshot data, on the basis of the page sum, and may manage the snapshot data. Dropping of snapshot data may mean deleting the snapshot data or processing the snapshot data as an invalid page.

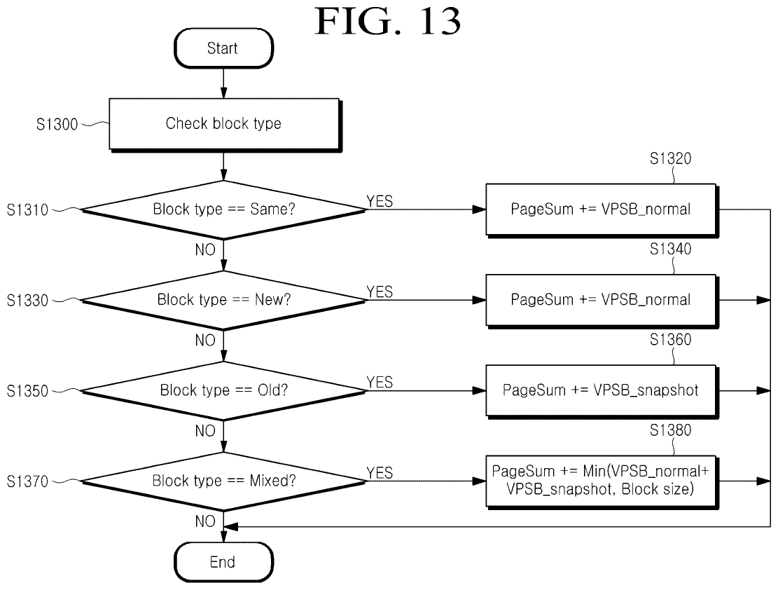

FIG. 13 is a diagram illustrating an example of a method in which the storage device determines a page sum depending on the type information of a storage block according to the embodiments of the present disclosure.

Referring to FIG. 13, in order to determine whether to drop snapshot data, the controller 120 may determine a page sum on the basis of the type information of each storage block 300. In order to determine a page sum, the controller 120 may use at least one of the number of valid pages stored in a normal block and the number of snapshot pages stored in a snapshot block.

In order for determination of a page sum, the controller 120 may check the type information of each storage block 300 (S1300).

When the type information of the storage block 300 corresponds to “Same” as the first type (S1310), the controller 120 may determine a page sum using the number of valid pages of a normal block (S1320). In the process of determining a page sum by summing the numbers of pages of respective storage blocks 300, the number of valid pages of a normal block whose type information is the first type may be used. Alternatively, because it is a state in which the number of valid pages of a normal block and the number of snapshot pages of a snapshot block are the same, a page sum may be determined using the number of snapshot pages.

When the type information of the storage block 300 corresponds to “New” as the second type (S1330), the controller 120 may determine a page sum using the number of valid pages of a normal block (S1340).

When a valid page that is added after a snapshot operation is stored in a normal block or when a normal block is a storage block 300 that is generated after a snapshot operation, because the number of valid pages stored in the normal block is greater than the number of snapshot pages stored in a snapshot block, the controller 120 may determine a page sum using the number of valid pages of the normal block.

When the type information of the storage block 300 corresponds to “Old” as the third type (S1350), the controller 120 may determine a page sum using the number of snapshot pages of the snapshot block (S1360). A page sum may be calculated by adding the number of snapshot pages to a page sum calculated for previous storage blocks 300. Because it is a state in which at least a part of valid pages stored in a normal block is changed to an invalid page, a page sum may be determined on the basis of the number of snapshot pages stored in a snapshot block.

When the type information of the storage block 300 corresponds to “Mixed” as the fourth type (S1370), the controller 120 may determine a page sum on the basis of a smaller value among the sum of the number of valid pages of a normal block and the number of snapshot pages of a snapshot block and the size of the storage block 300 (S1380).

Because at least a part of valid pages stored in a normal block is a new valid page that is added after a snapshot operation, the at least a part of the valid pages may be different from the snapshot pages stored in the snapshot block. Because a part of the valid pages stored in the normal block is a page that is changed to an invalid page after the snapshot operation, a part of the snapshot pages stored in the snapshot block may be different from the valid pages stored in the normal block.

Therefore, a page sum may be determined using the sum of the number of the valid pages of the normal block and the number of the snapshot pages. Because the number of valid pages (including snapshot pages) that actually require management may be equal to or smaller than the size of the storage block 300, a smaller value among the sum of the number of valid pages and the number of snapshot pages and the size of the storage block 300 may be used when determining a page sum.

In some implementations, the controller 120 may determine a page sum using the sum of the number of valid pages and the number of snapshot pages. Alternatively, when the type information of the storage block 300 corresponds to the fourth type, the controller 120 may determine a page sum on the basis of the number of snapshot pages of a snapshot block.

On the basis of the type information of each storage block 300, the controller 120 may determine a page sum using at least one of the number of valid pages of a normal block or the number of snapshot pages of a snapshot block corresponding to the normal block. The controller 120 may control whether to maintain or drop snapshot data, on the basis of a determined page sum.

For example, when a determined (calculated) page sum is equal to or greater than a preset threshold value, the controller 120 may drop snapshot data. The controller 120 may drop snapshot data without receiving a command from the host device 200. Dropping of snapshot data may mean deleting snapshot data or managing snapshot data as an invalid page, but the present disclosure is not limited thereto. When a predetermined condition is satisfied, the controller 120 may efficiently manage the storage space of the memory 110 while managing the backup data of valid pages stored in the memory 110 by organizing snapshot data.

In addition, depending on a result of comparing a page sum and a plurality of preset threshold values, the controller 120 may control whether to drop snapshot data.

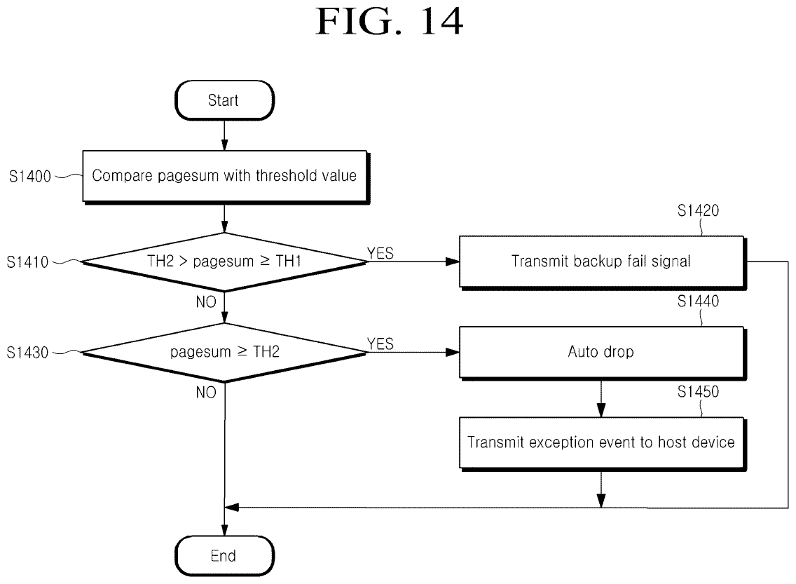

FIG. 14 to FIG. 16 are diagrams illustrating examples of a method in which the storage device controls dropping of snapshot data on the basis of a page sum according to the embodiments of the present disclosure.

Referring to FIG. 14, the controller 120 may compare a determined page sum with a preset threshold value (S1400). In some implementations, the controller 120 may drop a snapshot block when the page sum is equal to or greater than the preset threshold value. Alternatively, the controller 120 may determine whether to maintain or drop a snapshot block, depending on a result of comparing a page sum and a plurality of threshold values, and may control dropping of the snapshot block.

For example, when the page sum is equal to or greater than a preset first threshold value (S1410), the controller 120 may transmit a backup fail signal to the host device 200 in response to a backup request from the host device 200 (S1420).

The controller 120 may drop snapshot data when a page sum is equal to or greater than a threshold value, but may manage the storage space of the memory 110 while maintaining the size of snapshot data to at least a predetermined size. The host device 200 may transmit a backup request to the controller 120 separately from a snapshot by the controller 120. The host device 200 may transmit a backup request periodically, or may transmit a backup request when the size of data requested to be written to the storage device 100 is equal to or larger than a predetermined size.

When receiving a backup request from the host device 200, the controller 120 may back up data stored in the memory 110 according to the backup request, and may transmit a backup completion signal to the host device 200. When the page sum determined by the aforementioned method is equal to or greater than the first threshold value at the time of receiving the backup request, the controller 120 may transmit the backup fail signal to the host device 200 without performing an operation of backing up data stored in the memory 110. Because it is a state in which the storage space of the memory 110 is not sufficient, the controller 120 may transmit the backup fail signal to the host device 200 in response to the backup request from the host device 200.

In this case, in order to secure a space for storing backup data of data stored in the memory 110, the host device 200 may instruct the storage device 100 to perform a garbage collection operation, or may transmit, to the storage device 100, a command that instructs unmapping (demapping) of some data. After the storage space of the memory 110 is secured, the host device 200 may transmit a backup request again to the storage device 100.

When the page sum is equal to or greater than a preset second threshold value (S1430), the controller 120 may drop a snapshot block that stores a snapshot page (S1440). The second threshold value may be greater than the first threshold value. In the example, the controller 120 drops a snapshot block or drops a snapshot page stored in a snapshot block.

The controller 120 may drop a snapshot block stored in the memory 110 without a command received from the host device 200. When a page sum is equal to or greater than a preset threshold value such as the second threshold value, the controller 120 may drop a snapshot block to secure the storage space of the memory 110.

When dropping the snapshot block, the controller 120 may transmit, to the host device 200, an exception event signal that includes information on the dropping of the snapshot block (S1450).

On the basis of the exception event signal received from the controller 120, the host device 200 may check that the storage space of the memory 110 of the storage device 100 has increased. If necessary, the host device 200 may transmit a backup request to the storage device 100, or according to the increased storage space, may transmit, to the storage device 100, a command that requests to write new data.

When necessary, the controller 120 may easily perform, through a snapshot operation, restoration of valid pages stored in the memory 110, and may efficiently manage the storage space of the memory 110 by dropping a snapshot block on the basis of a page sum.

In some implementations, the controller 120 may also manage snapshot data including a method of dropping a snapshot block, under the control of the host device 200.

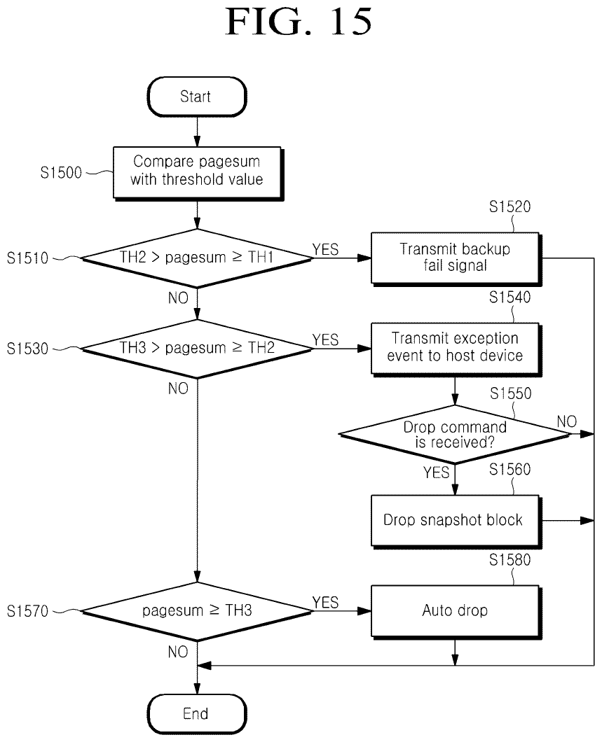

For example, referring to FIG. 15, the controller 120 may compare a determined page sum with a preset threshold value (S1500).

The controller 120 may check whether the page sum is equal to or greater than a first threshold value (S1510). When the page sum is equal to or greater than the first threshold value, the controller 120 may transmit, upon receiving a backup request from the host device 200, a backup fail signal to the host device 200 (S1520).

The controller 120 may check whether the page sum is equal to or greater than a second threshold value (S1530). The second threshold value may be greater than the first threshold value. When the page sum is equal to or greater than the second threshold value, the controller 120 may transmit an exception event signal to the host device 200 (S1540). The exception event signal may include information indicating that a page sum calculated according to management of a snapshot block among the storage blocks 300 of the memory 110 is equal to or greater than a predetermined value.

The controller 120 may receive a command that instructs to drop a snapshot block, from the host device 200 in response to the exception event signal. When receiving a command that instructs to drop a snapshot block, from the host device 200 (S1550), the controller 120 may drop the snapshot block (S1560). When not receiving a command that instructs to drop a snapshot block, from the host device 200 after transmitting the exception event signal, the controller 120 may maintain the snapshot block without dropping the snapshot block. When dropping the snapshot block according to the command from the host device 200, the controller 120 may transmit, to the host device 200, an exception event signal that includes information on the dropping of the snapshot block.

The controller 120 may check whether the page sum is equal to or greater than a third threshold value (S1570). The third threshold value may be greater than the second threshold value. When the page sum is equal to or greater than the third threshold value, the controller 120 may drop a snapshot block of the memory 110 (S1580). The controller 120 may drop the snapshot block without receiving a command from the host device 200. The controller 120 may transmit, to the host device 200, an exception event signal that includes information on the dropping of the snapshot block. According to a command received from the host device 200 in response to the exception event signal, the controller 120 may perform a backup or may perform a garbage collection operation, an unmapping operation, etc.

The controller 120 may efficiently manage a period during which a snapshot block may be utilized, by, depending on a result of comparing a page sum and a threshold value, dropping a snapshot block on the basis of a command from the host device 200 or dropping a snapshot block on its own, and may prevent or minimize deterioration of the operational performance of the storage device 100 attributable to the lack of the storage space of the memory 110 due to the presence of the snapshot block.

In addition, in some implementations, the controller 120 may control the dropping of a snapshot block on the basis of a command from the host device 200.

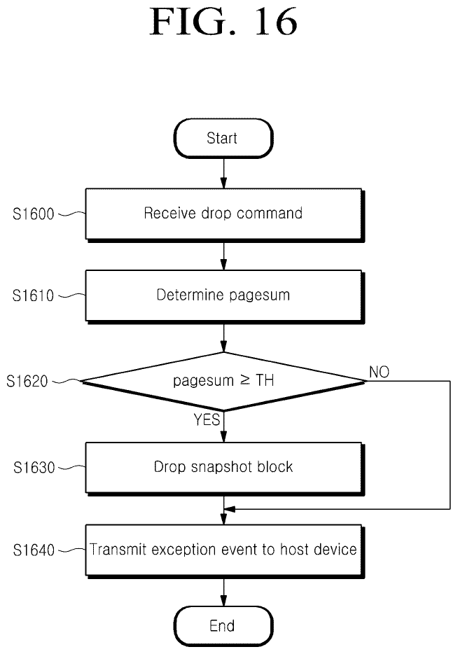

For example, referring to FIG. 16, the controller 120 may generate and manage a snapshot block that stores a snapshot page corresponding to a valid page stored in a storage block 300, through a snapshot operation.

The controller 120 may receive, from the host device 200, a command that instructs to drop a snapshot block (S1600). The host device 200 may transmit the corresponding command periodically or may transmit the corresponding command according to the need for the storage space of the memory 110.

In some implementations, when receiving, from the host device 200, a command that instructs to drop a snapshot block, the controller 120 may drop the snapshot block.

Alternatively, the controller 120 may determine a page sum using at least one of the number of valid pages of a normal block and the number of snapshot pages of a snapshot block depending on the type information of each storage block 300 (S1610). The controller 120 may check whether the page sum is equal to or greater than a preset threshold value (S1620).

When the page sum is equal to or greater than the preset threshold value at the time of receiving, from the host device 200, the command that instructs to drop the snapshot block, the controller 120 may drop the snapshot block (S1630). After dropping the snapshot block, the controller 120 may transmit, to the host device 200, an exception event signal that includes information on the dropping of the snapshot block (S1640).

In this way, the controller 120 may control whether to drop a snapshot block stored in the memory 110, by itself, or may control whether to drop a snapshot block stored in the memory 110, according to a command from the host device 200. By determining whether to drop a snapshot block, on the basis of a page sum calculated on the basis of the type information of each storage block 300, the controller 120 may efficiently manage the storage space of the memory 110 while maximally maintaining a period during which a snapshot page stored in a snapshot block may be utilized.

Although various embodiments of the present disclosure have been described with particular specifics and varying details for illustrative purposes, various modifications, additions and substitutions in the disclosed embodiments and other embodiments may be made based on what is disclosed or illustrated in the present disclosure.

What is claimed is:

1. A storage device comprising:
a memory including a plurality of storage blocks, each of the plurality of storage blocks including pages configured to store data, wherein at least one storage block of the plurality of storage blocks includes valid pages to which valid data is written; and
a controller in communication with the memory and configured to i) generate at least one snapshot block that stores snapshot pages that stores same data as the valid pages stored in the at least one storage block, ii) determine a page sum based on at least one of the number of the valid pages or the number of the snapshot pages depending on type information of each of the plurality of storage blocks, and iii) control whether to maintain the at least one snapshot block by comparing the page sum with at least one preset threshold value.

2. The storage device according to claim 1, wherein, in response to a new valid page being added to the least one storage block after the at least one snapshot block is generated, the controller is configured to determine the page sum based on the number of the valid pages of the storage block.

3. The storage device according to claim 1, wherein, in response to the valid pages stored in the at least one storage block and including the same data as the snapshot pages after the at least one snapshot block is generated, the controller is configured to determine the page sum based on the number of the valid pages of the storage block.

4. The storage device according to claim 1, wherein, in response to an occurrence of an invalid page in the at least one storage block after the at least one snapshot block is generated, the controller is configured to determine the page sum based on the number of the snapshot pages of the snapshot block corresponding to the storage block.

5. The storage device according to claim 1, wherein, in response to a new valid page being added to the at least one storage block after the at least one snapshot block is generated and an occurrence of an invalid page after the at least one snapshot block is generated, the controller is configured to determine the page sum based on a smaller value among the sum of the number of the valid pages of the at least one storage block and the number of the snapshot pages of the snapshot block corresponding to the at least one storage block and a size of the at least one storage block.

6. The storage device according to claim 1, wherein, in response to the page sum being equal to or greater than a first threshold value, the controller is configured to transmit a backup fail signal to a host device upon receiving a backup request received from the host device.

7. The storage device according to claim 6, wherein, in response to the page sum being equal to or greater than a preset second threshold value, the controller is configured to drop the at least one snapshot block, wherein the second threshold value is greater than the first threshold value.

8. The storage device according to claim 7, wherein, in response to dropping of the at least one snapshot block, the controller is configured to transmit, to the host device, an exception event signal that includes information on the dropping of the at least one snapshot block.

9. The storage device according to claim 8, wherein the controller is configured to perform a garbage collection operation or an unmapping operation based on a command received from the host device in response to the exception event signal.

10. The storage device according to claim 6, wherein, in response to the page sum being equal to or greater than a second threshold value, the controller is configured to i) transmit, to the host device, an exception event signal that indicates a need of dropping the snapshot block, and ii) drop the at least one snapshot block according to a command received from the host device in response to the exception event signal, wherein the second threshold value is greater than the first threshold value.

11. The storage device according to claim 10, wherein, in response to the page sum being equal to or greater than a third threshold value, the controller is configured to drop the at least one snapshot block, and transmit, to the host device, an exception event signal that includes information on dropping of the at least one snapshot block, wherein the third threshold value is greater than the second threshold value.

12. The storage device according to claim 1, wherein, in response to the page sum being equal to or greater than a preset threshold value, the controller is configured to drop the at least one snapshot block without receiving a command from a host device.

13. The storage device according to claim 1, wherein, in response to the page sum being equal to or greater than a preset threshold value, the controller is configured to drop the at least one snapshot block according to a command received from a host device.

14. The storage device according to claim 1, wherein, in response to a new valid page being added to the at least one storage block or a previously stored valid page being changed to an invalid page after the at least one snapshot block is generated, the controller is configured to update the type information of the at least one storage block.

15. A storage device comprising:
a memory including a plurality of storage blocks configured to store data; and
a controller in communication with the memory and configured to i) generate at least one snapshot block that stores snapshot pages storing same data as valid pages stored in at least one storage block of the plurality of storage blocks, and ii) control whether to maintain the at least one snapshot block based on a page sum determined based on a change state of the valid pages stored in each of the plurality of storage blocks after the at least one snapshot block is generated, wherein the change state indicates whether a change has occurred to the valid pages and information about the change in case that the change has occurred.

16. The storage device according to claim 15, wherein, in response to the number of the valid pages of the at least one storage block being maintained or increasing after the at least one snapshot block is generated, the controller is configured to use the number of the valid pages when determining the page sum, and in response to at least one of the at least one valid pages stored in the at least one storage block being changed to an invalid page, the controller is configured to determine the page sum based on the number of the snapshot pages of the snapshot block corresponding to the at least one storage block.

17. The storage device according to claim 15, wherein, in response to a new valid page being added to the at least one storage block and an occurrence of an invalid page after the at least one snapshot block is generated, the controller is configured to determine the page sum based on the number of the valid pages of the at least one storage block and the number of the snapshot pages of the snapshot block corresponding to the at least one storage block.

18. The storage device according to claim 15, wherein, in response to the page sum being equal to or greater than a preset threshold value, the controller is configured to transmit, to a host device, an exception event signal that requests a command for dropping of the at least one snapshot block, or drop the at least one snapshot block and transmit the exception event signal that includes information on dropping of the at least one snapshot block.

19. A storage device comprising:
a memory including a plurality of storage blocks, each of the plurality of storage blocks including pages configured to store data, wherein at least one storage block of the plurality of storage blocks includes valid pages to which valid data is written; and
a controller in communication with the memory and configured to i) generate at least one snapshot block that stores snapshot pages storing same data as the valid pages stored in the at least one storage block of the plurality of storage blocks, and ii) control dropping of the at least one snapshot block based on a command received from a host device after the at least one snapshot block is generated.

20. The storage device according to claim 19, wherein the controller is configured to transmit, to the host device, an exception event signal that requests a command for dropping of the at least one snapshot block, based on a result of comparing a page sum determined based on at least one of the number of the valid pages of the storage block or the number of the snapshot pages of the snapshot block and a preset threshold value.
